(19) United States
(12) Patent Application Publication
(10) Pub. No.: US 2011/0239019 A1
(43) Pub. Date: Sep. 29, 2011

(54) METHOD AND SYSTEM FOR MANAGING POWER CONSUMPTION OF A COMPUTING DEVICE

(75) Inventor: Christopher Lee Johnston, Harpers Ferry, WV (US)

(73) Assignee: UNISYS CORPORATION, Blue Bell, PA (US)

(21) Appl. No.: 12/730,150

(22) Filed: Mar. 23, 2010

(51) Int. Cl. G06F 1/32; G06F 1/28

(52) U.S. Cl. 713/323; 713/300

(57) ABSTRACT

A power-state management module in any operating environment manages power consumption of a computing device in a power-on mode. The disclosed system and method based on predetermined criteria, classify computing device activity and switch the computing device from the power-on mode to either a hibernate mode or a shut down mode. The predetermined criteria include inactive computing device time compared to a predetermined time period and operational processes present in an exemption list of processes.

### TECHNICAL FIELD

The presently disclosed embodiments deal generally with the field of computing devices, and more specifically with power consumption management of computing devices.

### BACKGROUND

In recent years, computers have become more powerful, and the number of devices available to users is expanding. As a result, the total power requirements of computer systems have increased, leading to demands for more sophisticated power management systems. Particularly, consumers increasingly demand power management systems that can detect computer system inactivity and automatically disable the power, facilitating energy conservation.

In contemporary power management systems, the original equipment manufacturer (OEM), and not the computer operating system, establishes the power management policy and provides the power management software. Existing power management systems involve power saving decisions based upon observed previous data, rather than real-time data.

At present, computer systems provide hibernation, a power management strategy that allows the computer systems to enter a dormant state rather than to completely shut off. Hibernation interrupts a task under execution and stores the existing operating state in a predetermined area of a hard disk under specified circumstances, such as an extended period of inactivity. Restoration from the hibernation state is referred to as “wake up”. That action restores the computer system to the state that was present when the computer system entered into hibernation mode, and it allows the computer system to resume the task in progress at that time.

Existing computer systems require network services to manage or change settings, especially in a distributed network environment. Microsoft Windows XP requires a directory service, such as Active Directory, for administering network information, synchronizing directory updates, and providing information security, for example. Active Directory is a hierarchical collection of network resources that can include users, computers, printers, other Active Directories, and Active Directory Services (ADS) that allow administrators to handle and maintain all network resources from a single location. Active Directory is a feature in a number of Windows systems. Additionally, ASP.NET applications permit users to authenticate against Active Directory. Only the Active Directory environment, however, manages system hibernation and shut down, limiting the flexibility of the computer system to switch from one power state to another.

### SUMMARY

Current power management methods in large enterprise environments focus primarily on built-in operating system features and restrict the flexiblility of power saving decisions of a computing device based on certain parameters, such as processor usage. Special applications and services associated with the computing device security solutions, desktop encryption, and firewalls, for example. In Microsoft Windows XP, if processor usage exceeds 10%, the operating system does not allow the computer system to enter hibernation. That result springs from an inherent assumption that whenever processes require 10% or higher processor usage, those processes should execute without interruption. This assumption is probably not valid, as certain applications and services, such as security solutions, desktop encryption, and firewalls, continuously run in the background and often lead to high processor usage. Typically, these applications and services can be terminated or paused during hibernate or shutdown without significantly affecting the computing device. For example, running certain processes such as Microsoft Exchange can elevate the processor usage to over 10%, preventing hibernation of the computing device.

Thus, there remains a need for a power management system that provides flexible power savings decisions based on user-selected settings that maximize execution efficiency and power savings.

The present disclosure describes a method for managing power consumption of a computing device in a power-on mode. In an embodiment, the method includes determining status and classifying activity of the computing device, based on predetermined criteria. The predetermined criteria can include inactive computing device time (compared to a predetermined time period) and a determination of whether operational processes are present in an exemption list of processes. The method may further switch the computing device from the power-on mode to either a hibernation mode or a shut down mode based on the status of the computing device and the predetermined criteria.

Another embodiment of the present disclosure describes a method for managing power consumption of a computing device in a power-on mode. The method includes determining the status of the computing device. If the status is a user “logged-on” status, the method identifies certain operational processes present in an exemption list, if no user input is detected to the computing device for at least a first predetermined time period. Otherwise, the method maintains the computing device in the power-on mode. Further, if no operational processes are identified as being present in the exemption list of processes, the method switches the computing device to a hibernate mode. Otherwise, the method maintains the computing device in the power-on mode. If the status is a user “logged-off” status and if no user is logged on to the computing device for at least a second predetermined time period, the method identifies the operational processes present in an exemption list of processes. Otherwise, the method maintains the computing device in the power-on mode. Further, if no operational processes are identified as being present in the exemption list of processes, the method switches the computing device to a shut down mode. Otherwise, the method maintains the computing device in the power-on mode.

Another embodiment of the present disclosure describes a power consumption management system for a computing device in a power-on mode. The system employs an exemption list and a status check module configured to determine the status of the computing device. The system may further employ a power-state management module for classifying computing device activity based on predetermined criteria, including inactive computing device time (compared to a predetermined time period) and a determination of whether operational processes are present in an exemption list of processes. In addition, the power-state management module may switch the computing device from the power-on mode to either a hibernation mode or a shut down mode based on the status of the computing device and the predetermined criteria.

### BRIEF DESCRIPTION OF THE DRAWINGS

The figures described below and attached hereto set out and illustrate a number of exemplary embodiments of the disclosure. Throughout the figures, like reference numerals refer to identical or functionally similar elements. The figures are illustrative in nature and are not drawn to scale.

FIG. 1 illustrates a block diagram of a computing device representing an exemplary operating environment for the claimed invention.

FIG. 2 illustrates a block diagram of an application program representing an exemplary embodiment of the claimed invention.

FIG. 3 is a flowchart illustrating steps of an exemplary method for managing power consumption of a computing device.

### DETAILED DESCRIPTION

The following detailed description is made with reference to the figures. Embodiments are described to illustrate the claimed invention, not to limit its scope, which is defined by the claims. Those of ordinary skill in the art will recognize a variety of equivalent variations on the description that follows.

### Overview

The present disclosure describes systems and methods for managing power consumption of a computing device in a power-on mode. The embodiments described here employ a status check module to determine status of the computing device and a power management module to manage power state of the computing device. The power management module classifies computing device activity based on predetermined criteria and may further switch the computing device from the power-on mode to either a hibernate mode or a shut down mode. The predetermined criteria can include inactive computing device time (compared to a predetermined time period) and a determination of whether operational processes are present in an exemption list of processes.

It should be noted that the description below does not set out specific details of manufacture or design of the various components. Those of skill in the art are familiar with such details, and unless departures from those techniques are set out, techniques and designs known in the art should be employed, and those in the art are capable of choosing suitable manufacturing and design details.

### Definitions

“Logged-on” status refers to the state of a computing device when a user explicitly chooses to log into a user account. The user action may involve system activity, such as, without limitation, mouse or keyboard input for selection of a “logged-on” status. Similarly, “logged-off” status refers to the state of the computing device when a user exits from a user account.

“Exemption list” refers to a list of certain processes, applications, services, or other similar executable programs that may not be terminated or paused during execution without significantly affecting the operation of the computing device.

“Hibernate mode” refers to a power state of a computing device where at least a portion of the contents of RAM are written to non-volatile storage, such as, without limitation, a file on hard disk or a separate partition, before some computer system components (by way of example, without limitation, graphic processing units (“GPU's”), Universal Serial Bus (“USB”) controllers, one or more banks of RAM, hard drives, or the like) are powered down, and/or at least a portion of the running applications, services, processes, and the like are terminated. In some embodiments, “hibernate mode” may be entered prior to completely powering off the computing system. On restoring the computing device to the pre-hibernation state, the contents of memory are reloaded and the corresponding applications, processes, services, etc., are reloaded and allowed to resume operation.

“Shut down mode” refers to a power state in which the computing device draws little or no power from any power source (i.e., it has been essentially turned “off”).

### Description of Embodiments

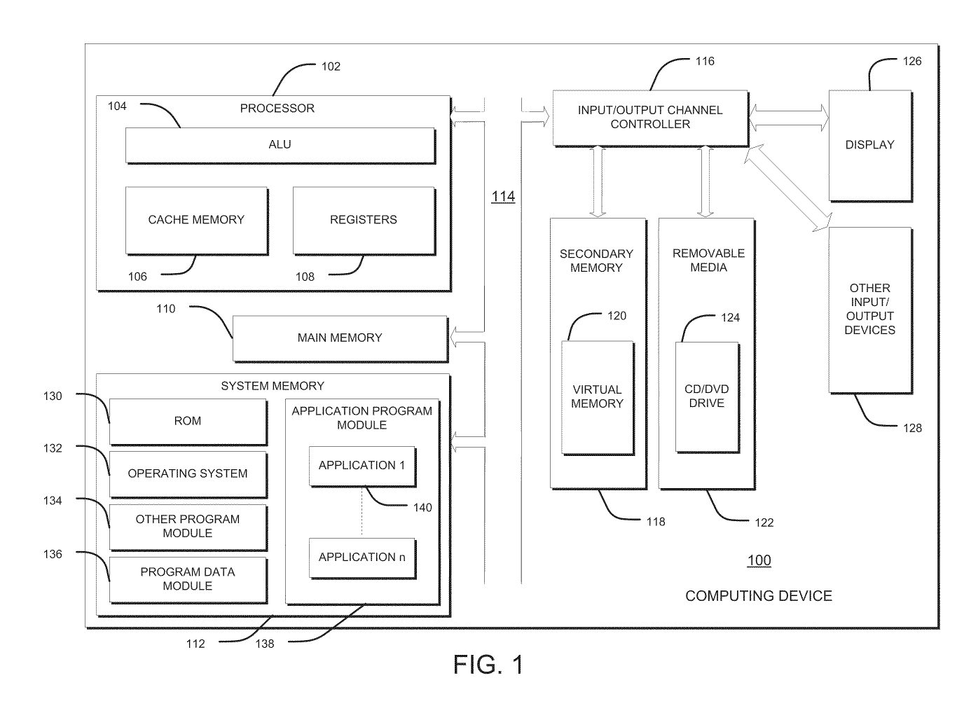

FIG. 1 illustrates a block diagram of a general-purpose computing device 100 representing an exemplary operating environment for the claimed invention. FIG. 1 illustrates various aspects of the computing environment in which an illustrative embodiment of the claimed invention is designed to operate. Those skilled in the art will immediately understand that FIG. 1 and the associated discussions are intended to provide a brief, general description of exemplary computer hardware and software modules, and that additional information is readily available in the appropriate programming manuals, user's guides, and similar publications.

FIG. 1 depicts the computing device 100 including a processor 102 having an arithmetic logic unit (ALU) 104 for performing arithmetic and logical operations, a cache memory 106 to reduce the average time to access memory and registers 108 for data storage, and registers 108. Additionally, the computing device 100 includes a main memory 110, a system memory 112, and a system bus 114. Further, the computing device 100 includes an input/output channel controller 116, a secondary memory 118 having a virtual memory 120, a removable media 122 having a CD/DVD drive 124, a display 126, and other input/output devices 128.

The main memory 110 typically refers to a form of semiconductor storage known as random-access memory (RAM). Generally, storage refers to mass storage-optical discs, forms of magnetic storage such as hard disk drives, and other devices which are typically slower but more permanent than RAM.

The system memory 112 includes a read-only memory (ROM) 130, an operating system 132, other program modules 134, a program data module 136, and an application program module 138. A basic input/output system (BIOS), stored in the ROM 130, contains start-up routines and basic routines that transfer information between components of the computing device 100.

The system bus 114 may be formed of any of the conventional bus structures, coupling the system memory 112 and other system components to the processor 102. The drives (including secondary memory 118 and removable media 122) and their associated computer-readable media typically provide non-volatile data storage, employing conventional media devices. The application program module 138 may include multiple application programs 140. The application program set may vary with each user, and it may include programs to accomplish tasks such as word processing, communications, and database management.

The embodiments of the disclosure may also be practiced in distributed computing environments where tasks are performed by remote processing devices linked through a communication network. In a distributed computing environment, program modules may be located in both local and remote memory storage devices.

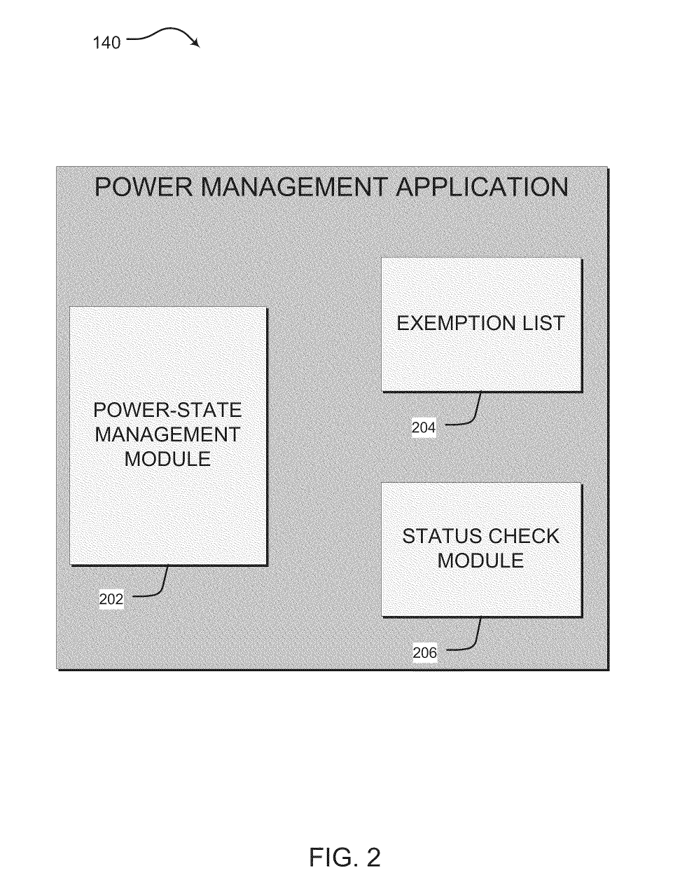

FIG. 2 illustrates a block diagram of a power management application 140 representing an exemplary embodiment of the claimed invention. Here, the application program module 138 includes the power management application 140, which manages power consumption of the computing device 100 in power-on mode. The power management application 140 includes a power-state management module 202, an exemption list 204, and a status check module 206.

The status check module 206 may determine the status of the computing device 100 in a power-on mode, which can be either a user “logged-on” status or a user “logged-off” status. If the computing device 100 status is “logged-on”, the power-state management module 202 may classify the computing device 100 activity by determining whether the computing device 100 has been inactive for at least a first predetermined time period. If the time for which the computing device 100 has been inactive is less than the first predetermined time period, the power-state management module 202 maintains the computing device 100 in the power-on mode. Otherwise, if the inactive time for the computing device 100 is greater than or equal to the first predetermined time period, the power-state management module 202 identifies operational processes and determines whether any of the identified operational processes are present in the exemption list 204. Upon determination of an operational process present in the exemption list 204, the power-state management module 202 maintains the computing device 100 in the power-on mode. Otherwise, the power-state management module 202 may switch the computing device 100 from the power-on mode to a hibernate mode.

If the computing device 100 status is “logged-off”, the power-state management module 202 may classify the computing device 100 activity by determining whether any user has been logged on to the computing device 100 for at least a second predetermined time period. As long as the computing device 100 has no “logged-on” users for a time less than the second predetermined time period, the power-state management module 202 maintains the computing device 100 in the power-on mode. If, however, the computing device 100 has no users logged on for a time greater than or equal to the second predetermined time period, the power-state management module 202 proceeds to identifying operational processes and determining whether any of the identified operational processes are present in the exemption list 204. Upon determination of an operational process present in the exemption list 204, the power-state management module 202 maintains the computing device 100 in the power-on mode. Otherwise, the power-state management module 202 may switch the computing device 100 from the power-on mode to a shut down mode.

The power-state management module 202 may either hibernate or shut down the computing device 100 based on the determination that no processes present in the exemption list 204 are operational. The processes on the exemption list may be, for example, without limitation, certain user-specified software installations, open database connections, queued print jobs that have not been printed, or the like. On determining that no such processes listed in the exemption list 204 are operational, the power-state management module 202 may hibernate, shut down, or otherwise cause the computing device 100 to enter a low power state.

In one example, to facilitate execution of the power management application 140, an installer application may generate registry settings and/or place a copy of an executable version of the power management application 140 (and/or any related files) in appropriate location. On installation, the software package generates registry settings to create and register a Windows service. The related files are copied to the corresponding folder directories. This installation procedure is well known to those in the art. The Windows service may check for logged on users, the predetermined time periods, and may further compare operational processes against the exemption list 204, as described above.

A folder may include a program executable file for the power management application 140 along with the exemption list file, accessed by the program executable file during execution of the power management application. By way of example, the exemption list 204 may be a text file at location c:\program files\u-hibernate\settings.ini, created by any suitable program or text editor. In some embodiments, an authorized user may add or remove processes from the exemption list 204 using a text editor.

Those skilled in the art will appreciate that the embodiments of the disclosure may be practiced on any machine in a large enterprise environment and further on other computer system configurations including, without limitation, hand-held devices, multiprocessor systems, and similar systems having interfaces, such as an application programming interface (API), facilitating interaction between users and computer systems.

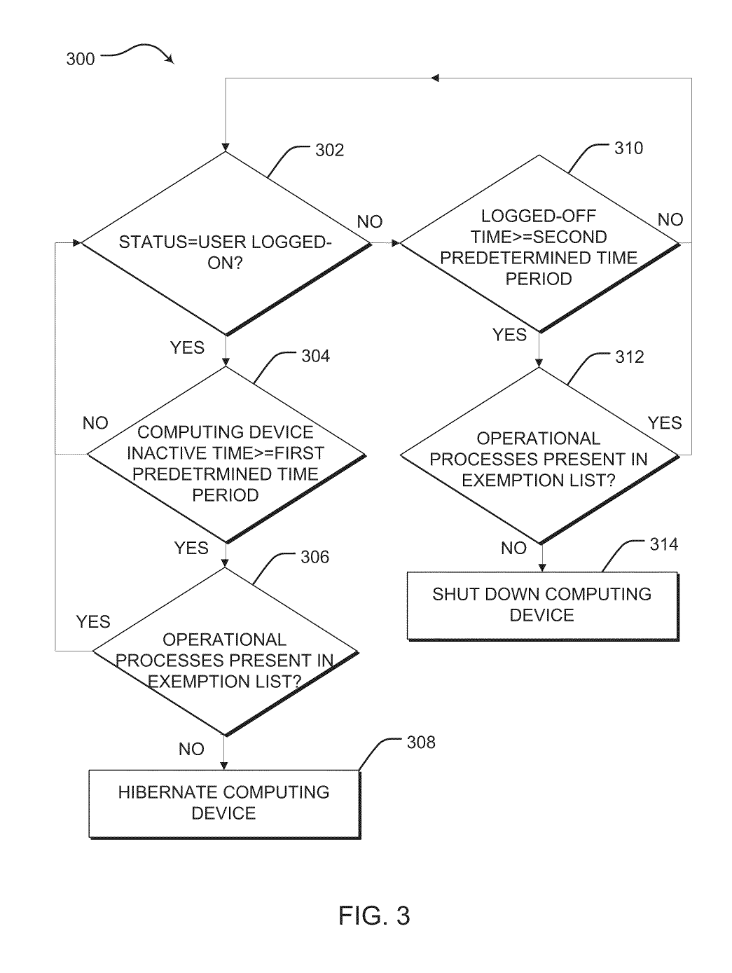

FIG. 3 is a flowchart illustrating an exemplary method 300 for managing power consumption in a computing device. The method 300 can be implemented in the computing device 100 described in connection with FIG. 1 and FIG. 2.

Block 302 illustrates the method 300 checking whether the status of the computing device 100 is “logged-on” through the status check module 206.

Upon determining that the computing device 100 status is “logged-on”, block 304 illustrates the power-state management module 202 determining whether the computing device 100 has been inactive (for example, without limitation, mouse or keyboard input) for at least a first predetermined time period. If the time for which the computing device 100 has been inactive is less than the first predetermined time period, the method 300 maintains the computing device 100 in the power-on mode, returning to the block 302.

If the inactive time for the computing device 100 is greater than or equal to the first predetermined time period, block 306 illustrates the method 300 identifying operational processes and determining whether any of the identified operational processes are present in the exemption list 204 through the power-state management module 202. For example, the first predetermined period may be two hours. If the computing device 100 has been inactive for less than two hours, the method 300 maintains the computing device 100 in the power-on mode. Otherwise, if the computing device 100 has been inactive for two hours or more, the block 306 illustrates the method 300 identifying operational processes and determining whether any of the identified operational processes are present in the exemption list 204 through the power-state management module 202. On determining that an identified operational process is present in the exemption list 204, the power-state management module 202 maintains the computing device 100 in the power-on mode, returning to the block 302. Block 308 illustrates switching the computing device 100 to the hibernate mode if no operational process is present in the exemption list 204.

If the block 302 determines that the computing device 100 status is “logged-off” (i.e. not logged-on), block 310 illustrates the power-state management module 202 determining whether the computing device 100 has maintained the user “logged-off” status for at least a second predetermined time period. If the computing device 100 has maintained the user “logged-off” status for a time less than the second predetermined time period, the method 300 maintains the computing device 100 in the power-on mode, returning to the block 302.

If, however, the computing device 100 has maintained the “logged-off” status for a time equal to or greater than the second predetermined time period, block 312 illustrates the method 300 identifying operational processes and determining whether any of the identified operational processes are present in the exemption list 204. For example, the second predetermined time period may be thirty minutes. If computing device 100 has been in the logged off state for less than thirty minutes, the method 300 maintains the computing device 100 in the power-on mode. Otherwise, if no user has logged on to the computing device 100 for thirty minutes or more, the block 312 illustrates the method 300 identifying operational processes and determining whether any of the identified operational processes are present in the exemption list 204, through the power-state management module 202.

The power-state management module 202 maintains the computing device 100 in the power-on mode if an operational process is present in the exemption list 204 and returns to the block 302. Block 314 illustrates switching the computing device 100 to the shut down mode, if no operational process is present in the exemption list 204.

In some embodiments, if the computing device 100 is required to switch from power-on mode to hibernate mode, shut down mode, or other such low/no power mode, the method 300 can facilitate change in power-state by terminating or hibernating certain applications or services without significantly affecting the computing device 100 based on the contents of exemption list 204. For example, in traditional Windows XP implementations, if the processor usage exceeds 10%, the operating system does not allow the computing device 100 to hibernate. By contrast, according to some embodiments of the disclosed system and methods, if no operational process is found as being present in the exemption list 204, the computing device 100 may enter hibernate mode even if the processor exceeds 10% usage, thus conserving energy. Similarly, in some embodiments in which the computing device status is “logged-off,” the computing device 100 may enter shut down mode if no operational process is found as being present in the exemption list 204. In addition, the features of the present disclosure eliminate the requirement of having Active Directory manage or change settings of the computing device 100.

The specification has set out a number of specific exemplary embodiments, but persons of skill in the art will understand that variations in these embodiments will naturally occur in the course of embodying the subject matter of the disclosure in specific implementations and environments. It will further be understood that such variations, and others as well, fall within the scope of the disclosure. Neither those possible variations nor the specific examples set above are set out to limit the scope of the disclosure. Rather, the scope of claimed invention is defined solely by the claims set out below.

What is claimed is:

1) A method for managing power consumption of a computing device in a power-on mode, the method comprising:
determining the status of the computing device;
classifying computing device activity based on predetermined criteria including:
inactive computing device time compared to a predetermined time period; and
operational processes present in an exemption list of processes; and
switching the computing device power-state mode based on the status and the predetermined criteria.

2) The method of claim 1, the power-state mode being a low power mode.

3) The method of claim 2, the power-state mode being either a hibernate mode or a shut down mode.

4) The method of claim 1, the status determination comprising determining whether at least one user is “logged-on” to the computing device.

5) The method of claim 4, the status determination resulting in a “logged-off” status if no users are logged on to the device.

6) The method of claim 4, the identification of operating processes being performed only when the computing device has been inactive for at least a first predetermined time period, or otherwise.

7) The method of claim 6, wherein the computing device is determined to be inactive, if no user input is detected to the computing device within a predetermined time period.

8) The method of claim 6, the switching comprising switching the computing device to the hibernate mode if no operational processes are identified as being present in the exemption list of processes.

9) The method of claim 6 further comprising maintaining the computing device in the power-on mode if one or more operational processes are identified as being present in the exemption list of processes.

10) The method of claim 5 further comprising, if a logged-off status has been determined, identifying the operational processes which appear in the exemption list of processes on the determination that the computing device has been inactive for at least a second predetermined time period.

11) The method of claim 10, the computing device being determined to be inactive if no user is logged on to the computing device.

12) The method of claim 10, wherein the switching step includes switching the computing device to the shut down mode, if no operational processes are identified as being present in the exemption list of processes.

13) The method of claim 10 further comprising maintaining the computing device in the power-on mode, if one or more operational processes are identified as being present in the exemption list of processes.

14) A method for managing power consumption of a computing device in a power-on mode, the method comprising:
determining the status of the computing device;
upon a determination that the status is a “logged-on” status:
identifying operational processes present in an exemption list of processes, on the determination that no user input to the computing device is detected for at least a first predetermined time period; and
switching the computing device to a hibernate mode if no operational processes are identified as being present in the exemption list of processes;
upon a determination that the status is a “logged-off” status:
identifying operational processes present in an exemption list of processes, on the determination that no user is logged on to the computing device for at least a second predetermined time period;
switching the computing device to a shut down mode if no operational processes are identified as being present in the exemption list of processes.

15) A power consumption management system for a computing device in a power-on mode, the system comprising:
an exemption list;
a status check module configured to determine status of the computing device;
a power-state management module configured to:
classify computing device activity based on predetermined criteria including:
inactive computing device time compared to a predetermined time period; and
operational processes present in the exemption list of processes; and
switch the computing device to a power-state mode based on the status and the predetermined criteria, wherein the power-state mode is either a hibernate mode or a shut down mode.

16) The system of claim 15, wherein the status is a user “logged-on” status.

17) The system of claim 15, wherein the status is a user “logged-off” status.

18) The system of claim 16, wherein the power-state management module is further configured to (1) identify the operational processes present in the exemption list of processes, on the determination that the computing device has been inactive for at least a first predetermined time period, or otherwise, (2) maintain the computing device in the power-on mode.

19) The system of claim 18, wherein the computing device is determined to be inactive, if the power-state management module detects no user input to the computing device.

20) The system of claim 18, wherein the power-state management module is further configured to switch the computing device to the hibernate mode, if the power-state management module identifies that no operational processes are present in the exemption list of processes.

21) The system of claim 18, wherein the power-state management module is further configured to maintain the computing device in the power-on mode, if the power-state management module identifies that one or more operational processes are present in the exemption list of processes.

22) The system of claim 17, wherein the power-state management module is further configured to (1) identify the operational processes present in the exemption list of processes, on the determination that the computing device has been inactive for at least a second predetermined time period, or otherwise, (2) maintain the computing device in the power-on mode.

23) The system of claim 22, wherein the computing device is determined to be inactive, if no user is logged on to the computing device.

24) The system of claim 22, wherein the power-state management module is further configured to switch the computing device to the shut down mode, if the power-state management module identifies that no operational processes are present in the exemption list of processes.

25) The system of claim 22, wherein the power-state management module is further configured to maintain the computing device in the power-on mode, if the power-state management module identifies that one or more operational processes are present in the exemption list of processes.
